(19) United States
(12) Patent Application Publication
(10) Pub. No.: US 2008/0177672 A1
(43) Pub. Date: Jul. 24, 2008

(54) METHOD FOR MANAGING LIABILITY

(76) Inventors: Robert BRUNNER, Western Springs, IL (US); Gerald Haberkorn, LaGrange, IL (US); Marshall Reavis, Lake Bluff, IL (US)

Correspondence Address: BEEM PATENT LAW FIRM, 53 W. JACKSON BLVD., SUITE 1352, CHICAGO, IL, 60604-3787, US

(21) Appl. No.: 11/625,940

(22) Filed: Jan. 23, 2007

(51) Int. Cl. G06Q 40/00

(52) U.S. Cl. 705/36 R; 705/37

(57) ABSTRACT

A method for allowing a second party manager to manage the liability of a first party funded liability issuer by either removing at least a fraction of the funded liability from the issuer's balance sheet or at least offsetting it with a guarantee from the manager to cover the risk of redemption of the liability. The manager will receive a discounted payment of consideration in exchange for taking on the liability. However, the payment will either be calculated such that the liability assumed will likely never be redeemed, minimizing the manager's risk, or else the payment may be invested such that the final value should exceed the potential risk of redemption.

### BACKGROUND OF THE INVENTION

1. Field of the Invention

The invention relates to the field of financial risk reduction and, in particular, to enabling a managing party to assist a funded liability issuer in improving its financial standing by being able to remove long-term, funded liabilities from its balance sheet.

2. Description of the Related Art

Prepaid gift cards and frequent flier and/or other loyalty programs are used extensively these days. One recent study estimates that retailers sold $82 billion worth of gift cards in 2006 alone. Of those, it is predicted that more than $8 billion worth will never be redeemed. Retailers have received this consideration, but cannot book it to revenue on their balance sheets until the cards are actually redeemed.

In 2004 and 2005 alone, airlines awarded almost 5 trillion frequent flier miles. During that span, travelers redeemed 1.528 trillion miles, resulting in a surplus of almost 3.5 trillion miles for just those two years. In fact, since 1981, the cumulative number of unredeemed frequent flier miles is over 14.2 trillion. An issuer may provide these miles or points in a couple different ways, each of which also attributes a different cash value per mile or point for the company. An airline or similar company may, for example, allow a consumer to earn one mile for every mile flown. Alternatively, the miles may be earned based on the cost of the purchase. For example, one mile or point is earned for every dollar spent on a ticket or a hotel room. Until these miles or points are redeemed by the customer, they remain on the issuer's balance sheet as a funded liability. In addition, while the miles might be earned at one mile per dollar spent and redeemed for less than 1% of that value, the issuer must keep sufficient cash on hand to pay for the fulfillment of the promise a member has for future travel. Even if these miles only cost an airline a fraction of a cent per mile, this still accounts for several billion dollars worth of liabilities on the airlines' balance sheet. In addition, most major hotel chains and credit card companies, among others, offer similar reward programs allowing consumers to earn points each time they stay at the hotel or make a qualifying purchase.

In both the gift card and frequent flier/loyalty program cases, although the issuer receives cash value for the card or the points at the time of the initial transaction, it cannot book the cash to revenue until the card or points are actually redeemed. Thus, the company has significant liabilities on its balance sheet but does not know when they will be redeemed, if ever. Several states prohibit retailers from putting expiration dates on these cards so, in theory, the liabilities could remain on the balance sheet forever. In fact, it is likely that a percentage of the funded liability may never be redeemed. As a result, an issuer that offers one of these programs not only must report a significant liability on its balance sheet, which negatively affects its borrowing ability, but it must also keep a sizeable amount of cash easily liquefiable in case the liabilities are redeemed, minimizing its investment options.

There have been attempts to address this problem of long-term, funded liabilities remaining on the issuer's balance sheet. U.S. Published application 2003/0004864 by Kregor, et al, discloses a method by which a liability issuer provides a financial incentive to the party to which the liability was issued to insure the risk of nonpayment or late payment of the liability, thereby minimizing the issuer's risk.

U.S. Pat. No. 7,076,446 by Kennard addresses the issue of unredeemed funded liabilities in the form of airline frequent flier miles. It teaches a method by which the number of unredeemed miles a participant retains is minimized by giving a participant greater flexibility in redeeming those miles. It sets a threshold number of miles below which the miles cannot be redeemed, but allows the participant to contribute a monetary amount to account for any shortfall if the participant has more than the threshold number of miles but fewer than the total normally needed for redemption.

U.S. Pat. No. 6,647,375 by Gelman, et al, discloses a method for reducing risk in order to derecognize debt. It teaches a method for taking a liability with a known future value and date at which it is due and calculating its present value for a given interest rate. A third party insurance company buys the liability at a premium, i.e., at a value greater than the present value of the liability. This allows the liability owner to discharge the liability and recognize the difference between the future value of the liability and the premium it paid to the third party as income. When the liability comes due, the third party will discharge the liability. In the interim, however, it may invest the premium so that it will be worth more than the known future value of the debt, thereby obtaining a profit on the transaction.

While the prior art relates generally to the field of the invention, none of it adequately addresses the needs of an issuer looking to remove the risk associated with a long-term funded liability from its balance sheet unless it also changes the nature of the agreement between the issuer and the party to whom the liability was originally issued.

### BRIEF SUMMARY OF THE INVENTION

A novel method for allowing a second party manager to manage the liability of a first party funded liability issuer. First, the amount of the issuer's funded liability is determined. Then, the parties ascertain the amount of the funded liability or the risk associated with that liability that the issuer is willing to transfer. A discounted amount of consideration to be received from the issuer in exchange for assuming the liability or risk is established. Once the amounts have been determined, the manager accepts the consideration from the issuer and assumes the transferable funded liability or its risk of redemption. In exchange, it confirms assumption with the issuer.

The method, as it relates to the situation caused by prepaid cards, may provide for the transferable liability being equal to approximately the amount of funded liability expected to remain unredeemed.

The method allows for flexibility in determining the time span in which funded liabilities are established. Among the allowable time spans, the method may be applied to funded liabilities that are acquired in an already completed time span, from a certain date until inception of the method, or from inception of the method moving forward in time.

In other aspects, such as those that relate to frequent flier or other loyalty programs, the method may allow for the transferable liability being equal to whatever amount the issuer is willing to transfer, regardless of the amount of funded liability that is expected to remain unredeemed.

In this aspect, the method involves investing the consideration received from the issuer for a period of time long enough to create a desired profit margin. The manager may either invest the consideration itself, or it may transfer the consideration to a third party financial manager in exchange for interest payments and a financial guarantee. At the end of the period of time, consideration is transferred back to the issuer, along with the payment of a premium, as is the transferred liability or its risk of redemption.

These and other features and advantages are evident from the following description of the present invention, with reference to the accompanying drawings.

### BRIEF DESCRIPTION OF THE DRAWINGS

FIG. 1 is a flow chart explaining the general method of the present invention.

FIGS. 2A-2B are a flow chart depicting an embodiment of the invention as it relates to the funded liability caused, for example, by prepaid gift cards.

FIGS. 3A-3E are a flow chart depicting an embodiment of the invention as it relates to the funded liability caused, for example, by frequent flier or other loyalty programs.

### DETAILED DESCRIPTION OF THE INVENTION

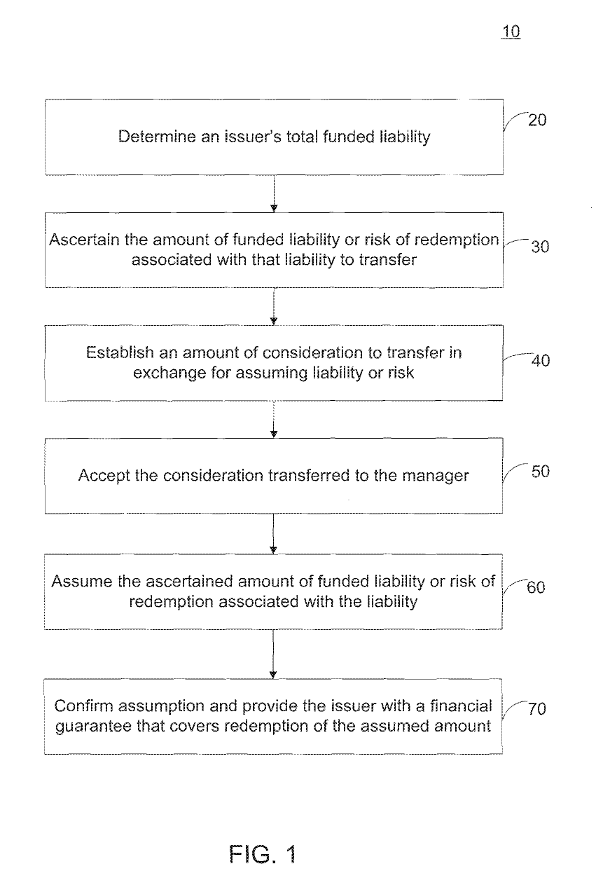

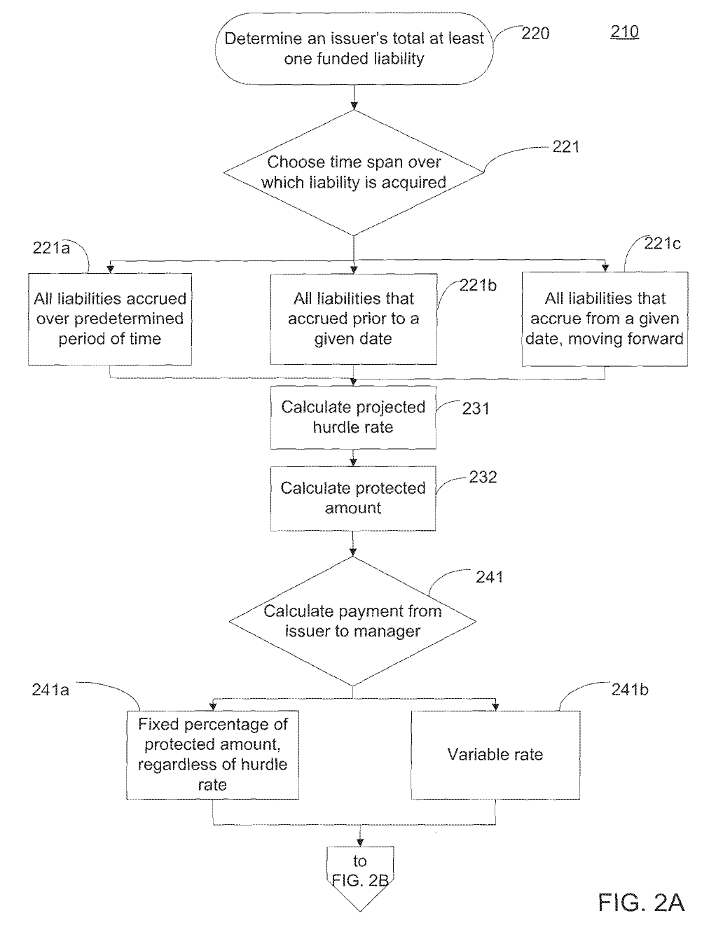

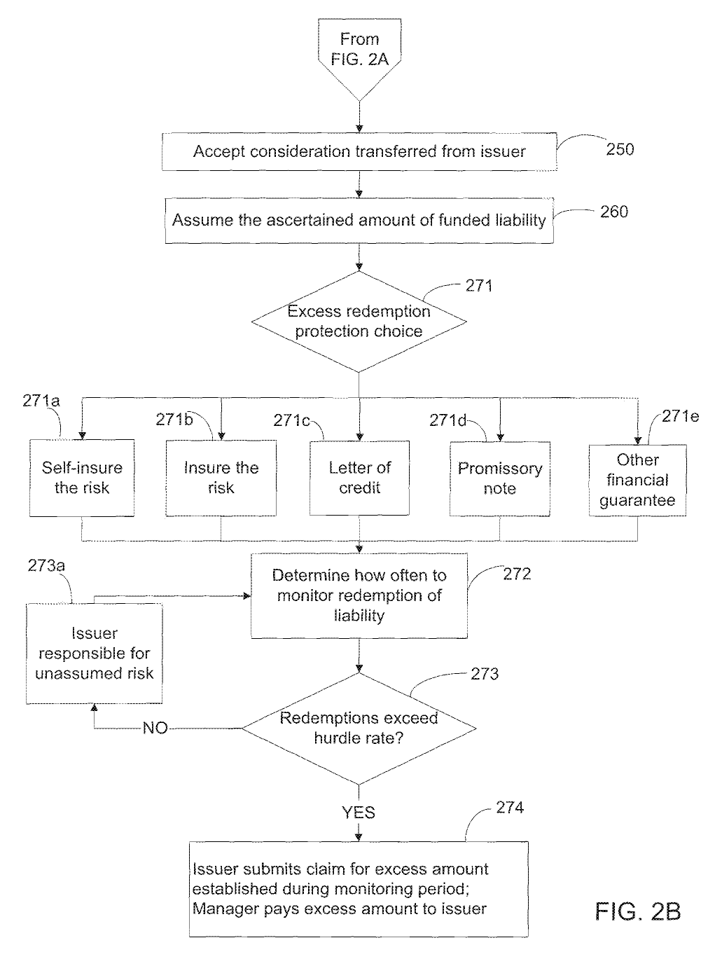

The invention relates to a new method 10 for improving the financial standing of a company, described broadly in FIG. 1. The embodiment shown in FIGS. 2A-2B discloses a method 210 as it relates to a company that acquires a funded liability by selling, for example, prepaid cards that may later be redeemed for the company's goods or services.

Turning to FIG. 1, a method 10 for managing liability is disclosed. Method 10 includes determining step 20 in which a second party manager determines a first amount of at least one funded liability that a first party issuer possesses. The liability has a known amount, but its redemption date is unknown.

Method 10 further includes ascertaining step 30 in which the manager ascertains a percentage of the funded liability or the risk of redemption of a percentage of the funded liability that it is willing to assume. In addition, method 10 includes establishing step 40 in which the amount of consideration the manager receives is determined. In accepting step 50, the manager receives the consideration determined in establishing step 40. In exchange, the manager also assumes the funded liability or risk of redemption associated with the funded liability that was determined in ascertaining step 30 at assuming step 60. The amount of the consideration the manager receives in accepting step 50 is less than the value of the funded liability or risk of redemption assumed in assuming step 60.

As part of assuming step 60, the funded liability issuer retains responsibility for payment of any funded liability that is redeemed but which risk was not assumed by the manager. Following assuming step 60, confirming step 70 provides that, after the issuer has covered redemption of the entire unassumed amount, the manager provides the issuer with some form of financial guarantee to assure that the manager is responsible for payment of any further redemption.

In one variation, method 10 contains an additional investing step 80 in which the manager may invest the consideration after it has been received from the issuer. Another variation of investing step 80 provides that the manager may transfer the consideration to a third party financial partner which will invest it and, in turn, provide the manager with interest payments for a calculated time over the course of method 10.

In another variation, method 10 contains additional returning step 90 that allows the financial partner to return the original amount of consideration to the manager at the end of the calculated period of time. Also in returning step 90, the manager may return the funded liability or risk of redemption to the issuer along with a second payment of consideration which value is greater than the first payment of consideration.

Turning now to FIGS. 2A-2B, what is disclosed is a method 210 to allow a funded liability issuer to bring forward a portion of its funded liabilities in order to improve its financial standing. This portion of liability may correspond, for example, to the expected unused balances on the prepaid cards it has issued. Method 210 includes a determining step 220 in which the manager determines a first amount of at least one funded liability that a first party issuer possesses. In one application, because it is already issued and is for a fixed amount, the liability has present and future values that are both known and equal.

Determining step 220 includes time span choice 221 at which the time span over which the funded liability acquired by the issuer is determined. Electing fixed time option 221a, the funded liability is established over a predetermined period of time, preferably one fiscal year. In this case, the manager receives the payment and assumes the liability from the issuer at the end of the time period. In clean-up option 221b, the funded liability results, for example, from all cards that an issuer sold from the inception of its program or its record-keeping until a given date. Under looking forward option 221c, the funded liability results, for example, from all cards that are sold after a given time. In this instance, every time the issuer sells a card after that date, an agreed-upon percentage of its value is automatically transferred to the manager along with an agreed-upon percentage of the funded liability, as calculated in ascertaining step 230.

At this step, the parties generally know that, beyond a certain percentage, a portion of the funded liability will never be redeemed. This amount, known as the “hurdle rate,” may be calculated at hurdle rate calculation 231 using tools commonly used in the art. With this information, a “protected amount” is then calculated at protected amount calculation 232, preferably by subtracting the hurdle rate from one hundred percent.

Knowing this information, the manager agrees to assume a percentage of the protected amount, preferably about all of it. In exchange, the funded liability issuer agrees to pay an amount of consideration to the manager and method 210 proceeds to establishing step 240. At this step, the amount of consideration the manager receives is calculated using payment calculation 241. How much consideration the funded liability issuer pays in comparison to how much liability the manager assumes may be either a fixed or variable relationship. The manager may elect fixed rate option 241a and charge the same percentage regardless of the hurdle rate. For example, if the hurdle rate is 70%, 85% or 98%, the manager may charge 20% of the protected amount. Preferably, however, the higher the hurdle rate, the lower the percentage of consideration required in the transaction, leading the manager to elect variable rate option 241b. In that case, if the hurdle rate for one industry is 98% for example, the issuer might only be required to pay 10% of the remaining 2%. However, if the hurdle rate is 70%, the issuer might have to pay as much as 50% of the remaining 30% that corresponds to the protected amount.

Once these amounts have been determined, method 210 proceeds to accepting step 250 in which the manager accepts the consideration that was calculated using payment calculation 241. Method 210 also proceeds to assuming step 260 in which the manager assumes a portion of the protected amount that was calculated using protected amount calculation 232, preferably all of it. Regardless of the hurdle rate or whether fixed rate option 241a or variable rate option 241b is chosen, the monetary value of the liability assumed is greater than the amount of consideration paid. In this embodiment, therefore, the funded liability issuer has to reduce the assets on its balance sheet by the amount of consideration it pays to the manager. However, it receives the benefit of being able to reduce its liabilities by a greater amount equal to the value of the funded liability the manager assumes.

Once the manager receives the liability and the consideration, method 210 proceeds to confirming step 270. Although the amount of the funded liability assumed, preferably calculated using protected amount calculation 232, is the amount of the funded liability that will likely never be redeemed, the manager has to guard against the risk of excess redemptions by making an election under redemption protection choice 271 of confirming step 270. As one option, the manager may self-insure against the risk of excess redemptions at self-insurance option 271a. If it has sufficient capital, it may pay out of its own pocket if the funded liability issuer submits a claim. Under insurance option 271b, the manager may insure the risk of excess redemption with an insurer. In letter of credit option 271c, the manager may provide the issuer with a letter of credit upon which the funded liability issuer can draw upon submission of a claim. Under promissory note option 271d, the manager may give the funded liability issuer a promissory note to guard against excess redemption. Finally, if none of these options suit either the manager's or the funded liability issuer's needs, the manager may elect to provide the first party with some other equivalent financial guarantee at other financial guarantee option 271e.

After the transfers occur, the parties must determine how often to monitor redemption of funded liabilities at redemption monitoring calculation 272. They must then determine if redemptions exceed the hurdle rate at redemption threshold calculation 273. If, during the course of method 210, redemptions remain below the hurdle rate, method 210 proceeds to first party responsible option 273a and the manager has no financial obligation to the first party funded liability issuer. If, however, redemptions exceed the hurdle rate, method 210 proceeds to claim submission and repaying step 274. At this step, the issuer submits a claim for the amount of excess funded liability redeemed during the previous monitoring period. In addition, the manager agrees to compensate the issuer for the excess amount of this redemption over the amount of funded liability assumed. In one variation, evaluation of redemption will occur quarterly at redemption threshold calculation 273 and, at that point, the issuer may submit a claim to the manager for the amount, if any, of the excess at claim submission and repaying step 274.

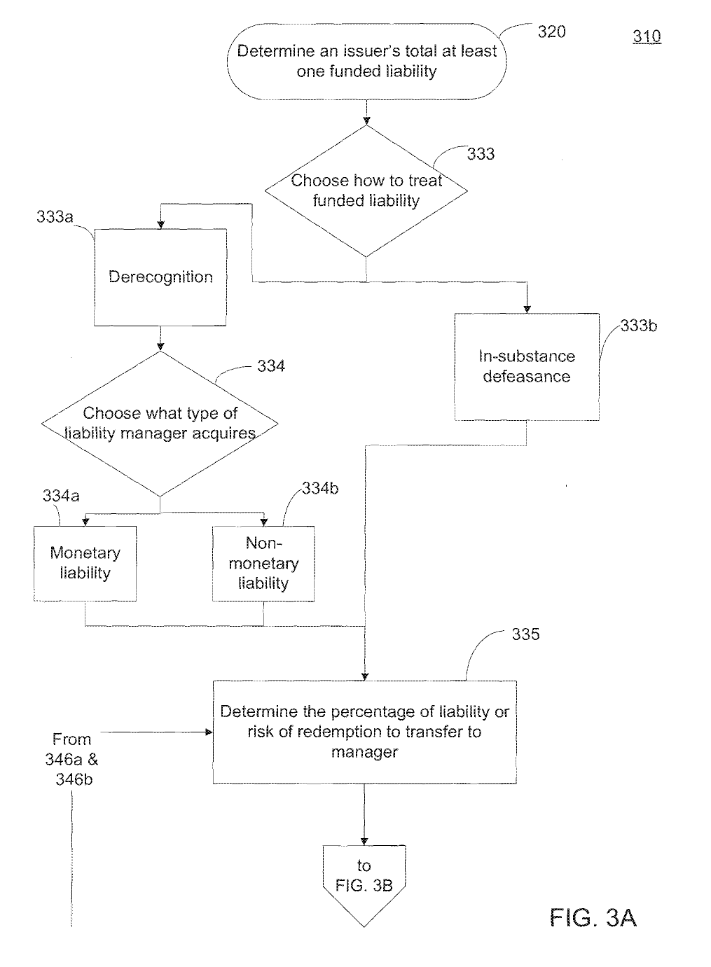

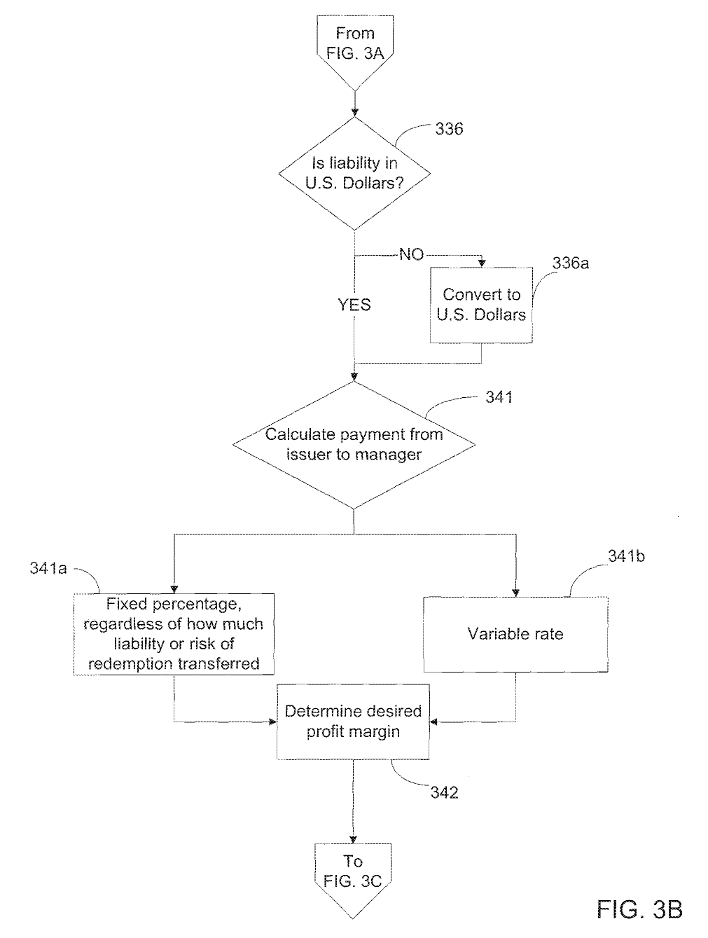

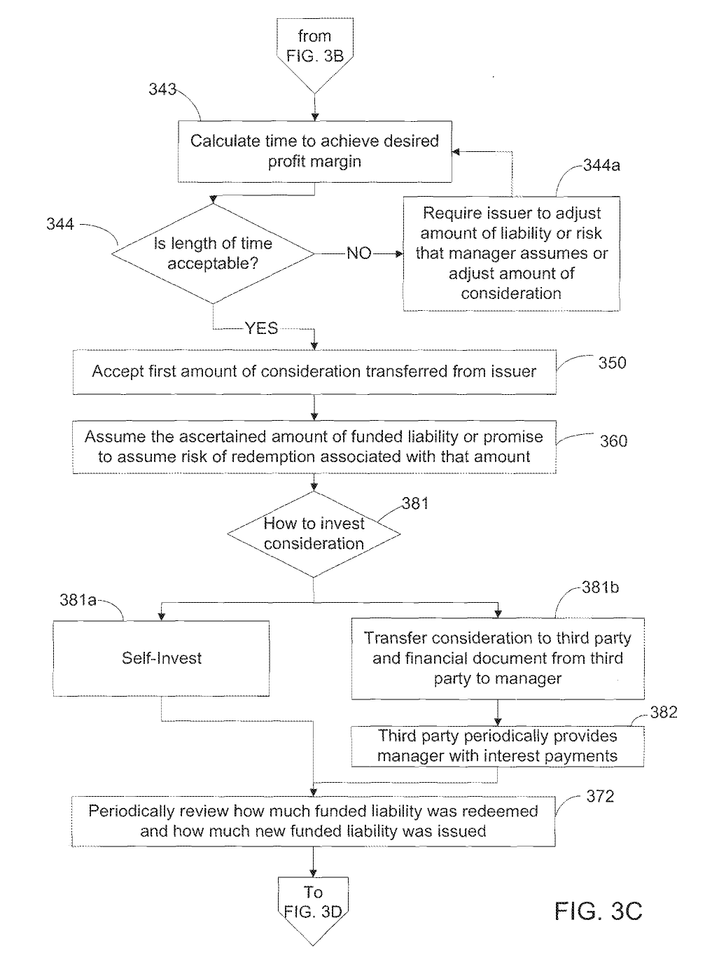

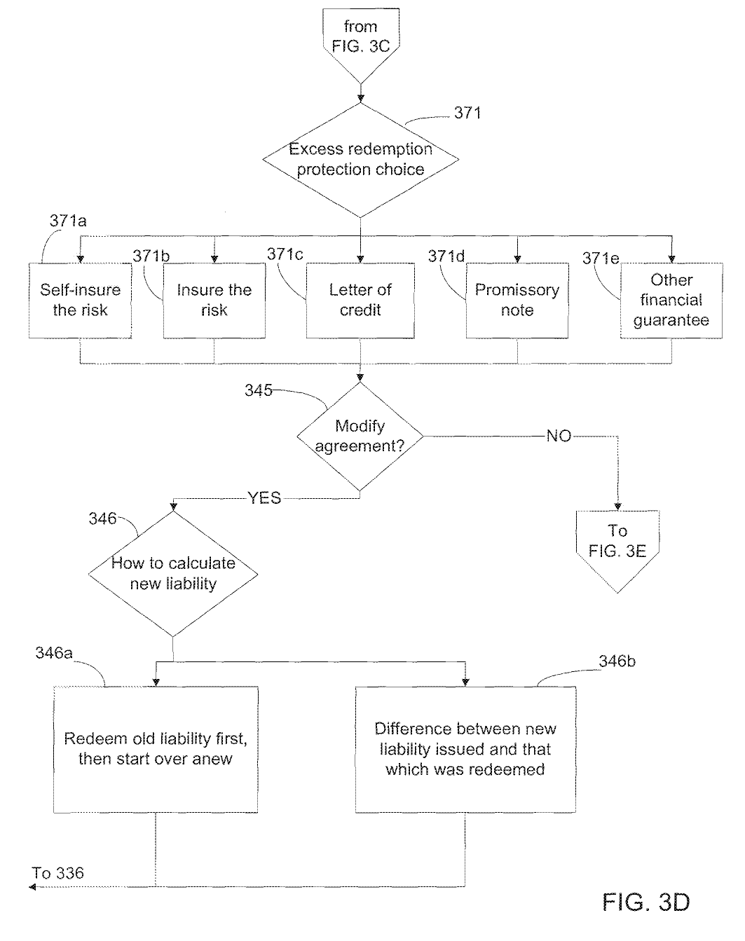

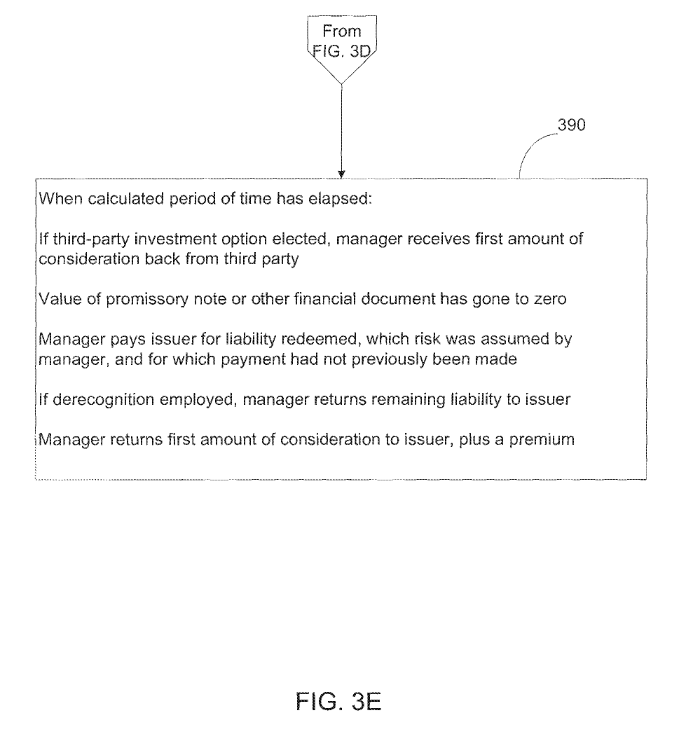

Turning now to FIGS. 3A-3E, the embodiment shown depicts method 310 for improving the financial standing of a company such as an airline, a hotel or a credit card company that issues frequent flier miles or reward points as part of a loyalty program. As in the previous embodiment, method 310 begins with determining step 320 in which the manager determines a first amount of at least one funded liability that a first party issuer possesses.

In order to ascertain how much liability or risk of redemption associated with the liability to transfer, method 310 includes liability treatment choice 333 in which the manager and issuer agree how to treat the funded liability. Under derecognition option 333a, the manager actually acquires the liability from the issuer. Further, if electing this option, method 310 requires using liability type choice 334 to choose what form the liability the manager acquires will take. The funded liability may be monetary, valued, for example, in dollars. In contrast, it may be non-monetary, valued, for example in points or miles. Monetary liability option 334a provides for the manager assuming responsibility for a percentage of the monetary liability, in one variation, calculated using the funded liability issuer's internal conversion rates. In contrast, under non-monetary liability option 334b, the manager assumes the responsibility for a percentage of the non-monetary liability valued at its monetary equivalent, calculated in one variation using the issuer's internal conversion rates.

In contrast to derecognition option 333a, by electing in-substance defeasance option 333b, the manager does not actually acquire the funded liability. Instead, the liability remains on the issuer's balance sheet. However, it is offset by the manager providing the first party with a financial instrument at confirming step 370 promising to cover the risk of redemption of this portion of the liability. In either case, the following steps are the same and will be described for the variation in which the liability is actually assumed. For in-substance defeasance, replace “funded liability” with “risk of redemption of the funded liability.”

Remaining with FIGS. 3A-3E, after the manager has decided whether to acquire the funded liability or proceed via in-substance defeasance, the percentage of funded liability to transfer to the manager is calculated at liability amount calculation 335. Preferably, the issuer will transfer all of it. Since the companies that issue these forms of liability may operate globally, one variation allows for currency choice 336 where the value of the funded liability is examined to see if it is in U.S. dollars. If not, it is converted to U.S. dollars using conversion option 336a.

In exchange for the manager agreeing to accept the funded liability, the issuer agrees to pay to the manager a first amount of consideration equal to some percentage of the transferring funded liability, determined at payment calculation 341. Preferably, the manager will choose fixed rate option 341a and charge a fixed percentage, regardless of how much funded liability is transferred. This percentage should be at least 50% for the transaction to be financially feasible. Preferably, the funded liability issuer pays a first amount of consideration equal to 75-80% of the amount of funded liability transferred. More preferably, the first party would pay 80%. In addition, the manager may choose variable rate option 341b and charge an amount that varies with the amount of the funded liability transferred. Preferably the more funded liability transferred, the higher the percentage charged.

Once the manager knows how much funded liability it is assuming from liability amount calculation 335 and has calculated how much it will charge at payment calculation 341, it ascertains its desired profit margin at profit margin determination 342. Knowing the initial value of the first amount of consideration it receives, its desired profit margin and a predetermined rate of interest, the manager calculates the time to achieve the desired profit margin at time calculation 343 using formulas well-known in the art. Preferably, the period of time will be calculated such that the first amount of consideration will grow to an amount equal to about twice the value of the funded liability transferred. More preferably, this period of time will be between 5-10 years. After determining the time span at time calculation 343, the manager determines if the length of time is acceptable at time acceptability choice 344. If the calculation results in a period of time outside the preferable 5-10 year span, the manager may still elect to proceed with method 310. If the manager believes the length of time is unacceptable, method 310 moves to adjustment option 344a. At this stage, the manager may require the issuer to adjust the amount of funded liability transferred or adjust the amount of consideration. Method 310 then reverts back to time calculation 343 to determine whether the newly calculated time falls within an acceptable range or is acceptable for other reasons.

Once time calculation choice 344 yields an acceptable result, method 310 proceeds to accepting step 350. At this step, the manager receives that first amount of consideration that was calculated using payment calculation 341. Method 310 also proceeds to assuming step 360 in which the manager assumes the funded liability from the issuer that was calculated using liability amount calculation 335.

Staying with the embodiment of FIGS. 3A-3E, once the manager receives the first amount of consideration from the funded liability issuer, it has the option to invest the first amount of consideration at investment choice 381. In one embodiment, the manager may elect self-investment option 381a and invest the consideration itself. In another embodiment, the manager may elect third-party investment option 381b and transfer the first amount of consideration, an amount thereof, or its monetary equivalent to a third party who is a financial partner. The financial partner will agree to invest the first amount of consideration at a predetermined rate of interest that will preferably be more favorable than what the issuer can receive by investing the first amount of consideration on its own. However, even if the interest rate is the same or even slightly lower than what the funded liability issuer may receive, method 310 is still beneficial to the issuer because it might be more valuable to reduce the amount of its liabilities than it is to invest the first amount of consideration or because it might have to keep an amount of cash equal to the first amount of consideration on hand to guard against excess redemptions of the liability.

In one variation of third-party investment option 381b, the financial partner will add funds of its own to the payment and invest the combined funds to maximize the amount of interest earned. Preferably, the amount of funds added will equal about the difference between the value of the funded liability assumed and the first amount of consideration. In addition, the third party will provide the manager with a first promissory note or other financial document at third-party investment option 381b and periodic interest payments at interest payment step 382 spread out over the period of time determined at time calculation 343. The initial value of the first promissory note will preferably be equivalent to the amount of additional funds the third party adds to the investment. Over time, the value of the first promissory note will decrease, ultimately reaching zero at the end of a calculated period of time. However, the total value of the interest payments received will preferably far exceed the initial value of the consideration transferred. At the end of the period of time, the financial partner agrees to return the consideration transferred back to the manager at returning step 390.

The issuer will periodically review its situation to determine how much liability was redeemed and how much new liability was issued at redemption monitoring calculation 372. After the issuer pays the manager at accepting step 350 and transfers a percentage of its funded liability at assuming step 370, the manager chooses how to protect itself against the risk of excess redemption at redemption protection choice 371. As with the embodiment of FIGS. 2A-2B, the manager may self-insure against the risk of excess redemptions at self-insurance option 371a. Under insurance option 371b, the manager may insure the risk of excess redemption with an insurer. In letter of credit option 371c, the manager may provide the issuer with a letter of credit upon which the issuer may draw upon submission of a claim. Under promissory note option 371d, the manager may give the issuer a promissory note to guard against excess redemption. Finally, if none of these options suit either the manager's or the issuer's needs, the manager may elect to provide the issuer with some other equivalent financial guarantee at other financial guarantee option 371e.

Under redemption threshold calculation 373, it is necessary to determine if the number of redemptions requires reimbursement by the manager. However, the issuer retains the risk of redemption of the untransferred miles or points or their cash equivalent under first party responsible option 373a. However, under confirming step 370, if redemptions exceed the amount of the funded liability retained by the first party, the second party will cover the cost of redemption of the excess.

Over the life of method 310, the parties may elect to renew and modify the agreement using modification choice 345. The funded liability issuer will have redeemed some of the old miles or points and issued new ones so the parties have to employ new liability calculation choice 346 to determine what the new funded liability to transfer will be. Under all new liability option 346a, the issuer submits a claim to the manager for the amount of the transferred funded liability that was redeemed and the manager compensates the issuer for that amount. Method 310 then reverts back to liability amount calculation 335. Any new funded liability established then becomes the basis for the amount the issuer wants to transfer.

If, instead, marginal liability option 346b is chosen, at the end of the period of time, the issuer, for example, calculates the number of new miles or points it issued as well as how many miles or points it redeemed since the start of method 310 or the last modification choice 345, and the difference between the two is the issuer's new funded liability and method 310 reverts back to liability amount calculation 336.

If one of the parties terminates method 310 before the time calculated in time calculation 343, it may be subject to payment of a penalty. Preferably, the penalty is calculated by returning all of the remaining unredeemed funded liability to the issuer but remitting only a fraction of the second amount of consideration.

If the parties elect not to modify the agreement at modification choice 345, at the end of the time calculated in time calculation 343, if third-party investment option 381b was elected, the financial partner transfers the first amount consideration back to the manager and the value of the promissory note or other financial document has gone to zero at returning step 390. Also at returning step 390, the manager pays the issuer for any previously unreimbursed, redeemed funded liability. Still further at returning step 390, the manager transfers any unredeemed funded liability back to the issuer so that the issuer will become responsible for any future redemption of that funded liability (miles or points, etc.). Having accumulated interest payments dispersed over the period of time, the manager will also repay the first consideration payment to the issuer at a premium, second amount of consideration, at returning step 390. Preferably, the amount of the premium is such that this total payment is about equal in value to the amount of the funded liability initially assumed. In addition, the payment will preferably be returned in the same currency in which it was received.

### EXAMPLE 1

The following table illustrates the redemption history over a two year span of a group of prepaid gas cards sold in January 2004 by a major retailer.

TABLE 1

| | Number of | Value of |
|---|---|---|
| Month, | Unredeemed | Unredeemed |
| Year | Cards | Cards |
| Issued: | 63,788 | $2,290,489.84 |
| January 2004 | 59,321 | $2,013,217.26 |
| February 2004 | 43,900 | $1,253,419.55 |
| March 2004 | 31,366 | $758,450.17 |
| April 2004 | 24,799 | $547,820.84 |
| May 2004 | 20,547 | $423,976.70 |
| June 2004 | 17,583 | $347,618.91 |
| July 2004 | 15,660 | $296,887.09 |
| August 2004 | 14,552 | $266,804.30 |
| September 2004 | 13,720 | $244,348.76 |
| October 2004 | 13,003 | $225,601.81 |
| November 2004 | 12,301 | $209,522.85 |
| December 2004 | 11,532 | $193,623.19 |
| January 2005 | 11,297 | $186,228.56 |
| February 2005 | 7,909 | $159,994.20 |
| March 2005 | 7,687 | $152,692.14 |
| April 2005 | 7,488 | $147,265.03 |
| May 2005 | 7,338 | $143,215.11 |
| June 2005 | 7,170 | $139,019.81 |
| July 2005 | 3,436 | $106,539.34 |
| August 2005 | 3,401 | $104,804.05 |
| September 2005 | 3,378 | $103,481.26 |
| October 2005 | 3,354 | $101,907.78 |
| November 2005 | 3,314 | $98,341.83 |
| December 2005 | 3,275 | $95,002.01 |
| January 2006 | 2,648 | $65,403.27 |

In the prepaid gas card sector, a major company issued 63,788 cards totaling $2,290,489.84 in January 2004. In July 2004, 15,660 of those cards, worth $296,887.09, had not been redeemed. In January, 2005, 11,297 cards with a total value of $186,228.56 had not been redeemed. Two years after their issuance, in January 2006, 2,648 cards worth $65,403.27 were not redeemed. This translates to a two-year hurdle rate of approximately 97.14% ($2,225,086.57/$2,290,489.84) and a protected amount of approximately 2.86% ($65,403.27/$2,290,489.84) for these cards. In addition, as of January 2006 the company had an additional 881,002 cards worth a total of $18,033,663.54 that were issued in the months between January 2004 and January 2006 but still not redeemed.

For the cards issued in January, 2004, if the initially calculated protected amount was 3%, the second party would assume liability for the value of all cards redeemed above $2,221,775.14, or 97% of the initial total worth of the cards. In other words, it would assume 3% of the value of the total liability of these cards, or $68,714.70. In exchange, if the two companies agreed on a consideration percentage of 10%, the first company would pay the second company $6,871.40 to assume this liability.

As of January 2005, $186,228.56 or 8.13% worth of cards had not been redeemed, still well above the protected amount. In this case, the first party would not be eligible to submit a claim for payment of redeemed cards to the second party.

However, as of January 2006, only $65,403.27 or 2.86% worth of cards had not been redeemed. Since the protected amount was exceeded by approximately 0.14%, or $3,311.43, the first party would present a claim to the second party for this amount. The second party would then pay this balance to the first party, using a self-insurance, insurance, letter of credit, promissory note or equivalent method.

The first party then reevaluates redemptions at a later date, preferably quarterly. If further redemptions occur in that time span, the first party may submit another claim, payment for which the second party has still guaranteed.

### EXAMPLE 2

The following table represents an industry-wide analysis of the frequent flier mile programs of the U.S. airline industry from 1981-2005.

TABLE 2

| | | | | | Cumulative |
|---|---|---|---|---|---|
| | Number of | Cumulative | Number of miles | Cumulative | unredeemed |
| | miles awarded | awarded miles | redeemed by | redeemed miles | miles/program liability |
| | by the airlines | to date | members | to date | to date |
| Year | (in billions) | (in billions) | (in billions) | (in billions) | (in billions) |
| 1981 | 4.1 | 4.1 | 1.9 | 1.9 | 2.2 |
| 1982 | 16.8 | 20.9 | 12.9 | 14.8 | 6.1 |
| 1983 | 38.3 | 59.2 | 28.6 | 43.4 | 15.8 |
| 1984 | 65.1 | 124.3 | 41.9 | 85.3 | 39 |
| 1985 | 94.3 | 218.6 | 57.3 | 142.6 | 76 |
| 1986 | 123.8 | 342.4 | 72.8 | 215.4 | 127 |
| 1987 | 163 | 505.4 | 81.3 | 296.7 | 208.7 |
| 1988 | 282.1 | 787.5 | 90.8 | 387.5 | 400 |
| 1989 | 337.6 | 1125.1 | 120.4 | 507.9 | 617.2 |
| 1990 | 394.1 | 1519.2 | 133.4 | 641.3 | 877.9 |
| 1991 | 443.3 | 1962.5 | 155.3 | 796.6 | 1165.9 |
| 1992 | 498.8 | 2461.3 | 178.6 | 975.2 | 1486.1 |
| 1993 | 583 | 3044.3 | 202.1 | 1177.3 | 1867.1 |
| 1994 | 644 | 3688.3 | 278.6 | 1455.9 | 2232.4 |
| 1995 | 661 | 4349.3 | 284.8 | 1740.7 | 2608.6 |
| 1996 | 830 | 5179.3 | 255.3 | 1996 | 3183.3 |
| 1997 | 980 | 6159.3 | 271.8 | 2267.8 | 3891.5 |
| 1998 | 1120 | 7279.3 | 403 | 2670.8 | 4608.5 |
| 1999 | 1290 | 8569.3 | 358.8 | 3029.6 | 5539.7 |
| 2000 | 1440 | 10009.3 | 349.5 | 3379.1 | 6630.2 |
| 2001 | 1600 | 11609.3 | 341.6 | 3720.7 | 7888.6 |
| 2002 | 1646 | 13255.3 | 402.9 | 4123.6 | 9131.7 |
| 2003 | 1730.6 | 14985.9 | 512.8 | 4636.4 | 10893.9 |
| 2004 | 2240.1 | 17226.0 | 633.6 | 5270.0 | 12367.3 |
| 2005 | 2714.1 | 19940.1 | 894.9 | 6164.9 | 14201.2 |

As can be seen in the table, the programs expand from year to year so that more new miles are being issued than are being redeemed. For this example, assume a first party airline has 10% of the total sales of frequent flier miles in the industry. In 1995, it therefore would have awarded 66.1 billion frequent flier miles. If each mile is worth one cent, this would be a total funded liability of $661 million. The airline wants the manager to assume the risk of all of the funded liability and is willing to pay 80% of the value, or $528.8 million, to do so. In this case, the manager may choose whether to accept the liability in monetary form or in the form of the miles themselves with the same cash equivalent. Either way, the issuer must reduce its assets by $528.8 million, but it may further reduce its liabilities by the full $661 million.

Assume the manager elects to align with a third party financial partner to invest the payment. Preferably, the financial partner will contribute $133 million to make the total investment equal the original $665 million and will provide the manager with a promissory note for $133 million. Also, for this example, the third party will be able to invest this amount and achieve a 12% rate of return on its investment. It would take approximately 5.2 years for the initial $532 million to double at a 12% interest rate, which is within the preferred 5-10 year range. The issuer might want to get the cash back sooner rather than later, and the manager might be willing to accept a slightly smaller profit margin, so they could set the arrangement for 5 years. Over these 5 years, the third party will provide the manager with interest payments and the value of the promissory note will steadily decrease to zero.

At the end of each year, the first party airline will calculate how many new miles it sold and how many miles it redeemed during the year. Assuming the same 10% market share, the first party in this example would have awarded 83 billion new miles, worth $830 million, and redeemed 25.53 billion miles in 2006.

The parties now have the option of renewing the agreement but must choose how to do so. Again, assume the manager is willing to assume all of the funded liability and the issuer will pay 80% of the value in cash in exchange. The manager may agree to cover redemption of the 25.53 billion miles and pay the issuer $255.3 million, and the issuer can pay 80% of the amount of the new liability, or $664 million and transfer the risk of redemption of all 83 billion miles to the manager.

Conversely, the difference between the new miles awarded and those redeemed in that year results in a net new funded liability of 57.47 billion miles. At the same one cent conversion rate, this new liability is worth $574.7 million. The manager would not have to pay the issuer for redeeming miles since they are taken into account in the new liability calculation. However, if the issuer wants the manager to assume the risk of this entire amount of new liability at the same 80% conversion rate, it would pay the second party $459.76 million.

The two parties may make this choice for each period of analysis, preferably yearly, over the course of the life of the agreement.

In addition, the parties may elect to not renew the agreement. Then, at the end of the first year, the issuer would submit a claim to the manager for the 25.53 billion redeemed miles. The manager would pay the issuer $255.3 million and reduce the amount of funded liability it still possesses by 25.53 billion miles to 40.97 billion miles. At the end of the next year, assuming the same 10% model, 27.18 billion miles will be redeemed. At 1 cent per mile, the manager would pay the issuer $271.8 million and reduce the amount of funded liability it still possesses by 27.18 billion miles to 13.97 billion miles. At the end of the year after that, 40.3 billion miles would have been redeemed, but the manager is only responsible for 13.97 billion of them and would pay the issuer $139.7 million.

While the foregoing written description of the invention enables one of ordinary skill to make and use what is considered presently to be the best mode thereof, those of ordinary skill will understand and appreciate the existence of variations, combinations, and equivalents of the specific exemplary embodiment and method herein. The invention should therefore not be limited by the above described embodiment and method, but by all embodiments and methods within the scope and spirit of the invention as claimed.

What is claimed is:

1. A method for managing liability, comprising:
(a) determining a first amount of an at least one funded liability of a first party issuer;
(b) ascertaining a second amount of transferable funded liability;
(c) establishing an amount of consideration to be received from said issuer, wherein said amount of consideration is less than or equal to said second amount of transferable funded liability;
(d) accepting said amount of consideration from said issuer;
(e) assuming said transferable funded liability or risk of redemption of said transferable liability from said issuer;
(f) confirming assumption of said transferable funded liability or of said risk of redemption of said transferable liability.

2. The method for managing liability of claim 1, wherein said second amount of transferable funded liability is about equal to a third amount of funded liability that is expected to be unredeemed.

3. The method for managing liability of claim 2, wherein said second amount of transferable funded liability is calculated using tools commonly applicable to the art.

4. The method for managing liability of claim 1, wherein said at least one funded liability has no fixed redemption date.

5. The method for managing liability of claim 1, wherein said at least one funded liability has accrued over a predetermined span of time.

6. The method for managing liability of claim 1, wherein said at least one funded liability has accrued prior to a predetermined time.

7. The method for managing liability of claim 1, wherein said at least one funded liability accrues after a predetermined time.

8. The method for managing liability of claim 1, wherein said at least one funded liability is evaluated periodically to determine a fourth amount of redeemed funded liability.

9. The method for managing liability of claim 8, wherein said at least one funded liability is evaluated monthly.

10. The method for managing liability of claim 1, wherein said amount of consideration is between about 10% and about 50% of said second amount of transferable funded liability.

11. The method for managing liability of claim 1, wherein said confirming step comprises self-insuring said assumption.

12. The method for managing liability of claim 1, wherein said confirming step comprises insuring said assumption.

13. The method for managing liability of claim 1, wherein said confirming step comprises providing a letter of credit to said issuer.

14. The method for managing liability of claim 1, wherein said confirming step comprises providing a promissory note to said issuer.

15. The method for managing liability of claim 1, wherein said confirming step comprises receiving a claim from said issuer for payment of a redeemed amount of said second amount of transferable funded liability or said risk of redemption of said second amount of transferable funded liability.

16. The method for managing liability of claim 15 wherein said claim is received quarterly.

17. The method for managing liability of claim 1, further comprising:
(g) investing said amount of consideration for a period of time;
(h) remitting said amount of consideration plus a second amount of consideration to said issuer at the end of said period of time;
(i) returning said second amount of transferable funded liability or risk of redemption of said second amount of transferable funded liability to said issuer.

18. The method for managing liability of claim 1, further comprising:
(g) transferring said amount of consideration to a third party in exchange for a financial guarantee and payments dispersed over said period of time;
(h) refunding by said third party said amount of consideration at the end of said period of time;
(i) remitting said amount of consideration plus a second amount of consideration to said issuer at the end of said period of time;
(j) returning said second amount of transferable funded liability or risk of redemption of said second amount of transferable funded liability to said issuer.

19. The method for managing liability of claim 17 wherein said at least one funded liability is of a non-cash form.

20. The method for managing liability of claim 17 wherein said second amount of transferable funded liability is about 100% of said first amount of said at least one funded liability.

21. The method for managing liability of claim 17 wherein said amount of consideration is worth at least about 50% of said first amount of an at least one funded liability.

22. The method for managing liability of claim 17 wherein said amount of consideration is worth about 75-80% of said first amount of an at least one funded liability.

23. The method for managing liability of claim 17 wherein said amount of consideration is worth about 80% of said first amount of an at least one funded liability.

24. The method for managing liability of claim 17, wherein said confirming step comprises self-insuring said assumption.

25. The method for managing liability of claim 17, wherein said confirming step comprises insuring said risk of redemption.

26. The method for managing liability of claim 17, wherein said confirming step comprises providing a letter of credit to said issuer.

27. The method for managing liability of claim 17, wherein said confirming step comprises providing a promissory note to said issuer.

28. The method for managing liability of claim 17 wherein the difference between said first amount of an at least one funded liability and said second amount of transferable funded liability is an untransferred amount of funded liability, said second amount of consideration worth about 100% of said untransferred amount of funded liability.

29. The method for managing liability of claim 17 wherein said period of time is sufficient to allow said amount of consideration to approximately double during said investing step.

30. The method for managing liability of claim 17 wherein second amount of transferable funded liability is calculated such that said amount of consideration will approximately double during said investing step in about 5-10 years.

31. The method for managing liability of claim 17 wherein said at least one funded liability is not in U.S. dollars.

32. The method for managing liability of claim 31 wherein said at least one funded liability is converted to U.S. dollars during said determining step.

33. The method for managing liability of claim 32 wherein said amount of consideration and said second amount of consideration are delivered to said issuer during said remitting step in the same currency in which they were received.

34. The method for managing liability of claim 17 further comprising paying a penalty for terminating said method before said period of time has elapsed.

35. The method for managing liability of claim 34 wherein said penalty is calculated by returning all of said second amount of transferable funded liability or risk of redemption of said second amount of transferable funded liability to said issuer but remitting only a fraction of said second amount of consideration.

36. The method for managing liability of claim 1, further comprising:
(g) Renewing said method at a time prior to said predetermined period of time.

37. The method for managing liability of claim 36 wherein said renewing step comprises:
(h) Determining a redeemed amount of said first amount of said at least one funded liability and reimbursing issuer for said redeemed amount;
(i) Determining whether issuer has a new amount of transferable funded liability and repeating said establishing, accepting, assuming and confirming steps with said new amount of transferable funded liability.

38. The method for managing liability of claim 36 wherein said renewing step comprises:
(h) Determining a redeemed amount of said first amount of said at least one funded liability and whether issuer has a new amount of transferable funded liability;
(i) Reimbursing issuer for the difference between said redeemed amount and said new amount and determining a remaining new amount of transferable funded liability;
(j) Repeating said establishing, accepting, assuming and confirming steps with said remaining new amount of transferable funded liability.
